(19) United States
(12) Patent Application Publication
(10) Pub. No.: US 2013/0346517 A1
(43) Pub. Date: Dec. 26, 2013

(54) PERSONAL MODE CONTEXTUAL PRESENCE

(71) Applicants: Jeffrey B. TRENT, Medford, NJ (US); Robyn J. CHAN, San Francisco, CA (US); Hanju KIM, Palo Alto, CA (US)

(72) Inventors: Jeffrey B. TRENT, Medford, NJ (US); Robyn J. CHAN, San Francisco, CA (US); Hanju KIM, Palo Alto, CA (US)

(73) Assignee: Magnet Systems, Inc., Palo Alto, CA (US)

(21) Appl. No.: 13/533,836

(22) Filed: Jun. 26, 2012

(51) Int. Cl. G06F 15/16

(52) U.S. Cl. 709/206

(57) ABSTRACT

Systems and processes for determining a contextual status of a resource, such as a user, using a contextual presence framework are described. A plurality of modes may be associated with the resource, where each mode represents a context of the resource. A presence value of the resource may be determined for each mode, which represents the extent to which the resource is engaged in the mode. An availability value of the resource may be determined for each mode, which represents the extent to which the resource is willing to be interrupted in the mode. A contextual presence status summary having a status summary availability value and a status summary presence value may be determined based on, for example, a weighted average of the presence values and a weighted average of the availability values of multiple modes of the resource.

### BACKGROUND

1. Field

The present disclosure relates to status information, and in one particular example, to determining the status of a user based on availability and presence.

2. Related Art

In some conventional communication systems, a user may use a status indicator to convey the user's current status to other users of the communication system. This conventional status indicator may simply indicate whether the user is logged into the service or not logged into the service. Users may further manually select their status indicator from among a set of status options, such as active, inactive, hidden, and offline.

Extensible Messaging and Presence Protocol, otherwise known as XMPP, is an instant messaging protocol designed by the XMPP Standards Foundation. An XMPP-compliant service is an example of a conventional communication system that allows users to set their status indicator. For example, users using an XMPP-compliant client to connect to an XMPP server may directly set their status indicator. This same status indicator may be seen by all other users with access to view the status indicator of the user. In another example, the XMPP service can communicate the current status of a user in a chat session to a chat partner by indicating whether the user is active, composing a message, or not available.

While conventional communication systems may be used to provide information about the user's status, they provide no contextual information based on the user's presence and availability in a mode. Presence may represent the degree to which the user is engaged in a particular mode and availability may represent the degree to which the user is willing to be interrupted while engaged in that mode. Because successful and convenient communication between users often depends on the context of the users, these conventional communication systems do not provide optimal status information.

### SUMMARY

Systems and processes for determining a contextual status of a resource, such as a user, using a contextual presence framework are described. A plurality of modes may be associated with the resource, where each mode represents a context of the resource. A first presence value of the resource may be determined for a first mode of the plurality of modes. The first presence value may be a real number representing the extent to which the resource is engaged in the first mode. A first availability value of the resource may also be determined for the first mode. The first availability value may be a real number representing the extent to which the resource is willing to be interrupted in the first mode. The first presence value and the first availability value may be stored in memory and communicated to a receiving system, such as an agent. Availability values and presence values may also be determined for other modes of the resource. For example, the modes of the resource may include a Work mode, a Home mode, a Social mode, and a Mobile mode. A contextual presence status summary having a status summary availability value and a status summary presence value may also be determined based on, for example, a weighted average of the presence values and a weighted average of the availability values of the modes of the resource.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary mobile communication device with which certain aspects and examples of the embodiments described herein may operate.

FIG. 2 schematically illustrates an exemplary relationship between contributing factors and a contextual presence status summary.

FIG. 3 illustrates an exemplary environment in which certain aspects and examples of the embodiments described herein may operate.

FIGS. 4A and 4B illustrate exemplary vector graphs for determining presence values and availability values.

FIG. 5 illustrates an exemplary process for determining and communicating a contextual presence status summary.

FIG. 6 illustrates an exemplary process for determining a presence value and an availability value of a contextual presence status summary.

FIG. 7 illustrates an exemplary block diagram for providing an application programming interface and a service provider interface.

FIG. 8 illustrates an exemplary display of the status information of a resource.

FIG. 9 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

Various embodiments are described below relating to systems and processes for determining a contextual status of a resource, such as a user, using a contextual presence framework. A plurality of modes may be associated with the resource, where each mode represents a context of the resource. A first presence value of the resource may be determined for a first mode of the plurality of modes. The first presence value may be a real number representing the extent to which the resource is engaged in the first mode. A first availability value of the resource may also be determined for the first mode. The first availability value may be a real number representing the extent to which the resource is willing to be interrupted in the first mode. The first presence value and the first availability value may be stored in memory and communicated to a receiving system, such as an agent. Availability values and presence values may also be determined for other modes of the resource. For example, the modes of the resource may include a Work mode, a Home mode, a Social mode, and a Mobile mode. A contextual presence status summary having a status summary availability value and a status summary presence value may also be determined based on, for example, a weighted average of the presence values and a weighted average of the availability values of the modes of the resource.

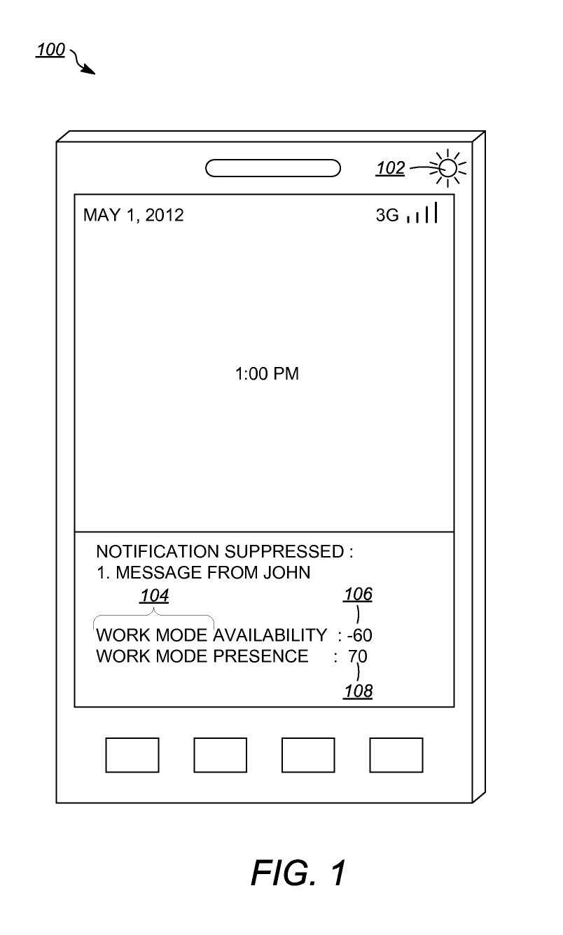

FIG. 1 illustrates an exemplary mobile communication device 100 with which certain aspects and examples of the embodiments described herein may operate. In one embodiment, a user may receive a message on mobile communication device 100 from a work contact. A notification coordinator service executing on the mobile communication device 100 may determine how to notify the user of the received message, if at all, based on a context of the user, the presence of the user, and the availability of the user.

The notification coordinator service may play an audio file, vibrate the mobile device, visually display a message indicator 102, or perform a combination of these techniques to notify the user of the received message. In order to determine the notification technique, the notification coordinator service may request the user's mode 104, presence value 106, and availability value 108. Based on the results of the requested information, the notification coordinator service may determine that the notification should be suppressed until a later time. In other circumstances, the notification coordinator service may determine that the user should be notified and in what manner, thus interrupting the user. Importantly, the user's mode 104, presence value 106, and availability value 108 are illustrated in FIG. 1 for demonstrative purposes, and need not necessarily be displayed.

A mode may represent a context in which a resource, such as the user previously described, is operating. A resource may be, for example, a conference meeting room, a printing device, a user, or the like. Presence represents whether the resource is engaged in a particular mode. In one example, presence value 106 may represent the degree to which the resource is engaged in the particular mode. In another example, presence value 106 may represent a confidence level that the resource is engaged in the particular mode. Availability value 108 may represent the degree to which the resource is willing to be interrupted while engaged in that particular mode. Using this information, the notification coordinator service may determine the appropriate technique for notifying the user of the received message.

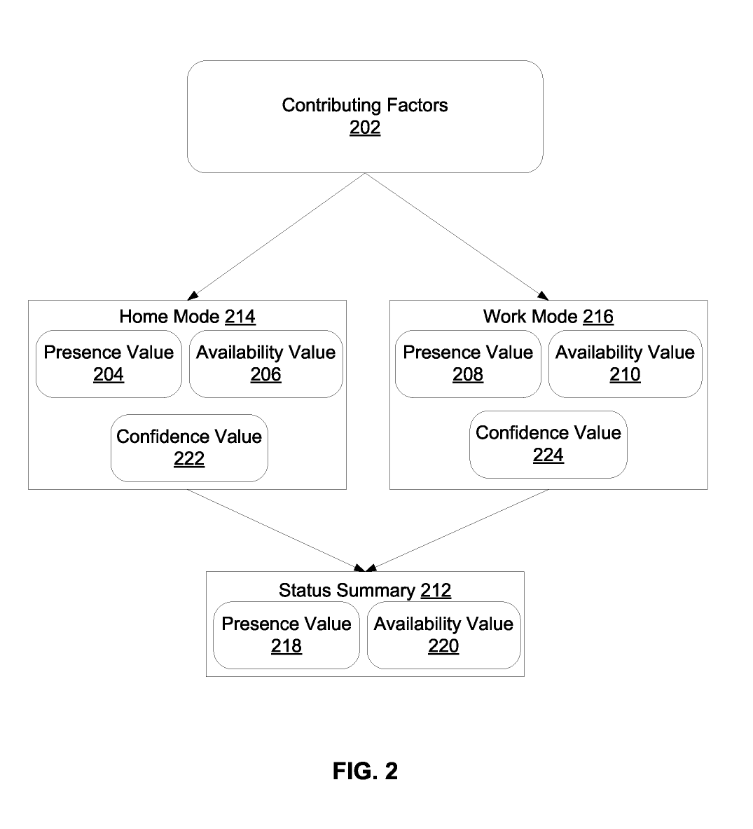

FIG. 2 schematically illustrates an exemplary relationship between contributing factors 202 and a contextual presence status summary 212. Contributing factors 202 may represent, for example, services, software and hardware functions, sensors, and the like, which provide context for a resource, such as a user. Contributing factors 202 may collect contextual information relating to the resource and may contribute transition information for one or more modes associated with the resource. The transition information may be, for example, scalar values for presence and availability for each of the modes associated with the resource. Thus, a resource may be associated with multiple modes, each mode having a presence value and an availability value.

Exemplary modes include a Home mode, a Work mode, a Social mode, a Mobile mode, and a Sleep mode. A Home mode may represent a resource engaging in domestic or household-related activities, such as performing house chores or purchasing groceries. A Work mode may represent a resource engaging in professional or work activities, such as working in the office or attending a meeting. A Social mode may represent a resource engaging in social activities, such as attending a birthday party or watching a performance at a theater with friends. A Mobile mode may represent a resource being in transit from one location to another, such as walking around town or sitting in a commuter train. A Sleep mode may represent a resource, such as a user, being engaged in a sleep-related activity, such as reading in bed or sleeping. One of ordinary skill in the art will recognize that many other modes are possible and that a resource may be engaged in more than one mode at a time.

Each mode is associated with a presence value and an availability value. For example, presence value 204 and availability value 206 may be associated with a Home mode 214 of a resource. Similarly, presence value 208 and availability value 210 may be associated with a Work mode 216 of the resource. Presence value 204 may represent the degree—or extent—to which the resource is engaged in the Home mode 214. Availability value 206 may represent the degree—or extent—to which the resource is willing to be interrupted while engaged in the Home mode 214. Similarly, presence value 208 may represent the degree to which the resource is engaged in the Work mode 216. Availability value 210 may represent the degree to which the resource is willing to be interrupted while engaged in the Work mode 216.

A status summary 212 of the resource may also be determined using the presence values 204, 208 and the availability values 206, 210. In one example, a status summary presence value 218 may be determined by selecting the larger of presence values 204, 208. Similarly, a status summary availability value 220 may be determined by selecting the larger of availability values 206, 210. In another example, confidence values 222, 224 may be associated with the availability value and presence value of each mode. A weighted average may be determined using the confidence values 222, 224, the presence values 204, 208, and the availability values 206, 210. Thus, the confidence value 222 of Home mode 214 may be used to weight the presence value 204 and the availability value 206 of Home mode 214. Similarly, the confidence value 224 of Work mode 216 may be used to weight the presence value 208 and the availability value 210 of Work mode 216. The weighted presence values may be combined to determine the status summary presence value 218. The weighted availability values may be combined to determine the status summary availability value 220.

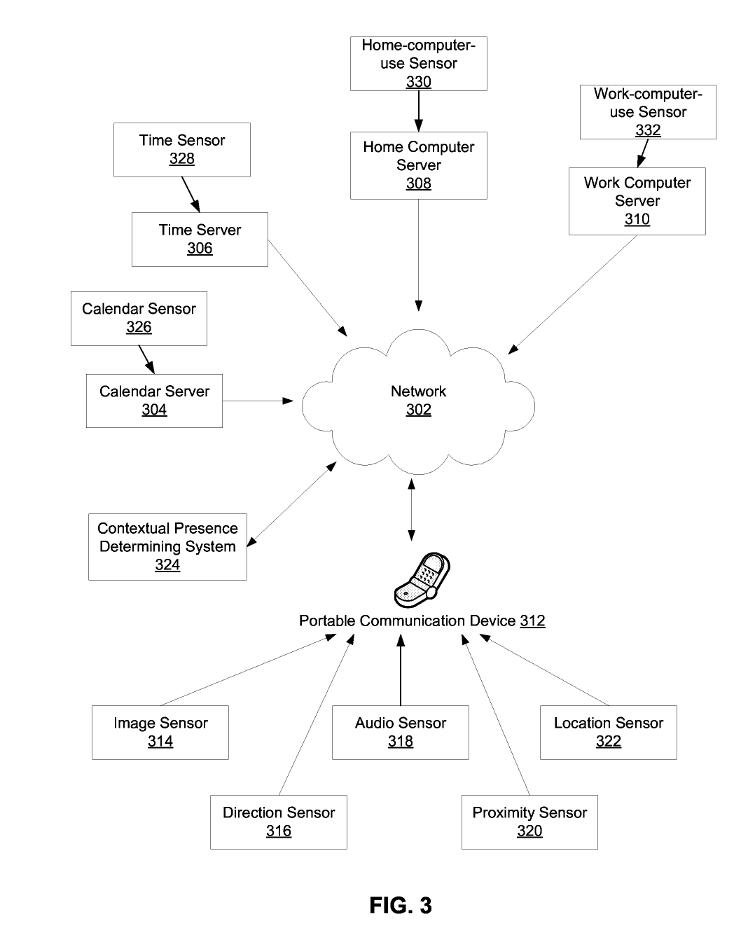

FIG. 3 illustrates an exemplary environment in which certain aspects and examples of the embodiments described herein may operate. In one embodiment, a computing device, such as portable communication device 312 determines the presence value and availability value of a resource, such as a user. In order to determine the values, the portable communication device 312 may communicate with contributing factors, such as image sensor 314, direction sensor 316, audio sensor 318, proximity sensor 320, and location sensor 322. Portable communication device 312 may also communicate with devices having contributing factors over a network 302 (e.g., the Internet or a Local Area Network (LAN)), such as calendar server 304 having a calendar sensor 326, time server 306 having a time sensor 328, home computer server 308 having a home-computer-use sensor 330, and work computer server 310 having a work-computer-use sensor 332. The remote and local contributing factors may each provide transition information for one or more modes of the user. The transition information may make positive or negative contributions to the availability values of multiple modes of the user and positive or negative contributions to the presence values of multiple modes of the user.

In another embodiment, contextual presence determining system 324 determines the presence value and availability value of a resource, such as a user. Contextual presence determining system 324 may be connected to network 302 (e.g., the Internet or a LAN). Contextual presence determining system 324 may communicate with devices having contributing factors, such as portable communication device 312 having image sensor 314, direction sensor 316, audio sensor 318, and proximity sensor 320 using network 302. The portable communication device 312 may be, for example, a cellular phone of the user. Similarly, contextual presence determining system 324 may communicate with calendar server 304 having a calendar sensor 326, time server 306 having a time sensor 328, home computer server 308 having a home-computer-use sensor 330, and work computer server 310 having a work-computer-use sensor 332 using network 302. It should be appreciated that contextual presence determining system 324 may also be connected directly to the contributing factors. The contributing factors may provide transition information for one or more modes of the user. The transition information may make positive or negative contributions to the availability values of multiple modes of the user and positive or negative contributions to the presence values of multiple modes of the user.

The transition information contributed by one or more contributing factors may also include a validity period, which includes a time period, a start time, and/or an end time to specify the time period for which the transition information is valid. For example, calendar sensor 326 may provide a contributing factor that is only valid for the duration of a scheduled and accepted calendar meeting.

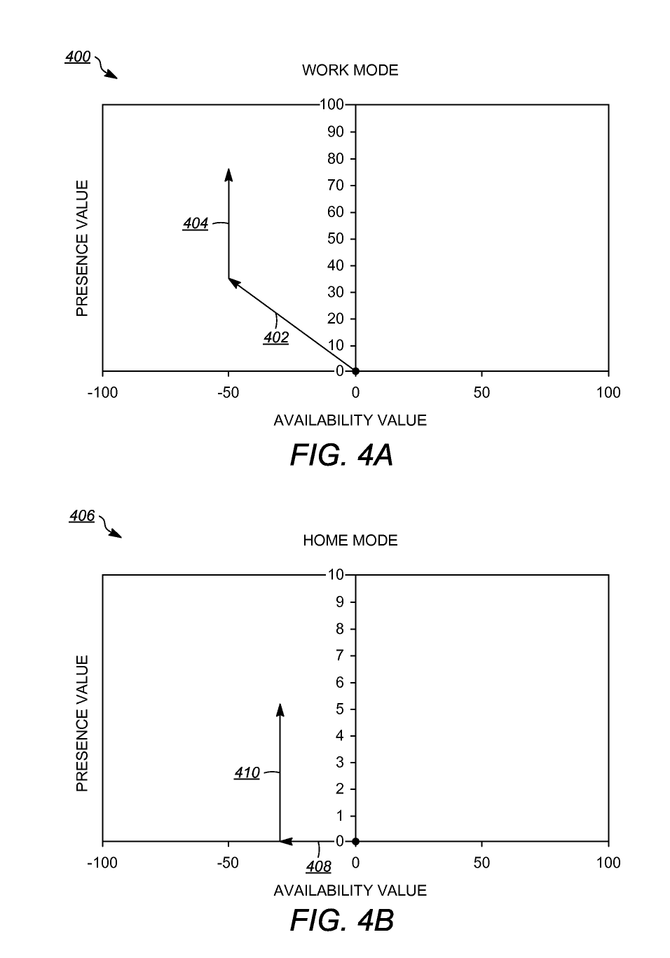

FIGS. 4A and 4B illustrate an exemplary vector graph for determining presence values and availability values. The range for presence values and availability values may vary. In one example, availability values may range from −100 to +100 and presence values may range from 0 to +100. In this particular example, an availability value of −100 for a mode may indicate a strong preference to not be disturbed in that mode and an availability value of +100 for the mode may indicate full accessibility for that mode. An availability value of 0 may be indicative of the user being “away.” A presence value of 0 for a mode may indicate that the user is not engaged in that mode, while a presence value of 100 for a mode may indicate that the user is fully engaged in that mode. A presence value of 50 for a mode may indicate that the user is partially engaged in that mode.

Importantly, a user may be “present” (presence value=100) in a mode, but “completely unavailable” (availability value=0) in that same mode. For example, a user may be at their job as a restaurant waiter, fully engaged in performing work-related tasks, such as taking a customer's meal order. This user may have a presence value of 100 for the Work mode, indicating the user is fully engaged in the Work mode. Simultaneously, the same user may have an availability value of 0 in the Work mode because the user is unwilling to be interrupted while they are engaging in the work-related tasks.

With respect to the discussion of FIGS. 4A and 4B, availability values may range from −100 to +100 and presence values may range from 0 to +100. However, in another example, availability values may range from 0 to +100, presence values may range from −100 to +100, and confidence values may range from 0 to +100. One of skill in the art will readily appreciate that the range for presence values, availability values, and confidence values may vary.

In one example, calendar server 304 of FIG. 3 may have contributing factor calendar sensor 326 that provides transition information for a Work mode and a Home mode of a user based on the user's calendar schedule. Referring to FIG. 4A, the transition information may provide a contribution of +35 towards the presence value of the user in the Work mode during the time the calendar server 304 determines that the user is scheduled to be in a work meeting. This reflects the degree to which the user is engaged in the Work mode during that time. The transition information may also provide a contribution of −50 towards the availability of the user in the Work mode during the time the calendar server 304 determines that the user is scheduled to be in the work meeting. This reflects the degree to which the user does not want to be interrupted while in the Work mode. This transition information, illustrated in FIG. 4A as vector 402 in graph 400, may be described as:

Transition_{calendar}(mode,availability,presence)=Transition_{calendar}(Work,−50,+35)

The contribution of the transition information from the calendar server 304 to the availability value and the presence value in the Work mode of the user may be based on any number of factors, such as meeting schedules (as described above), the attendees of a meeting, the number of attendees of the meeting, or the like. For example, the transition information contribution for the availability of the user may be further reduced by an additional determined value if the user is meeting with the user's manager, rather than with a coworker of the same rank as the user. This may reflect the user being less willing to be interrupted during a meeting with such a senior member of the user's work, as compared to a meeting with less senior members.

Continuing the example, location sensor 322 of FIG. 3 may provide transition information based on detecting that the portable communication device 312 is located within 150 yards of the user's place of business and is moving at a rate of less than one mile per hour. This may be interpreted as an indication that the user is engaged in the Work mode. However, the information may not provide any indication as to the user's availability. Thus, for example, the transition information contributed by the location sensor 322 for the Work mode under these circumstances, illustrated in FIG. 4A as vector 404 in graph 400, may be described as:

Transition_{location}_{_{—}}ₛₑₙₛₒᵣ(mode,availability,presence)=Transition_{location}_{_{—}}ₛₑₙₛₒᵣ(Work,0,+40)

Referring to FIG. 4B, calendar server 304 having calendar sensor 326 may also provide transition information for other modes of the user, such as the Home mode. The transition information may provide a contribution of 0 for the presence of the user in the Home mode during the time the calendar server 304 determines that the user is scheduled to be in the work meeting. This may reflect that the user is not engaged in the Home mode during that time. The transition information provided by calendar server 304 may also include a contribution to the availability of the user with respect to the Home mode, such as a contribution of −30. This transition information, illustrated in FIG. 4B as vector 408 in graph 406, may be described as:

Transition_{calendar}(mode,availability,presence)=Transition_{calendar}(Home,−30,0)

Similarly, location sensor 322 may also contribute transition information for the Home mode to reflect the user's location. For example, location sensor 322 may contribute a value of 5 to the presence of the user in the Home mode, and a value of 0 to the availability of the user in the Home mode. The transition information contributed by the location sensor 322 for the Home mode, illustrated in FIG. 4B as vector 410 in graph 406, may be described as:

Transition_{location}_{_{—}}ₛₑₙₛₒᵣ(mode,availability,presence)=Transition_{location}_{_{—}}ₛₑₙₛₒᵣ(Home,0,+5)

The combination of multiple transition information contributions by various contributing factors for a user may be used to determine the availability and presence of the user for one or more modes. In this example, the transition information contributions made by calendar server 304 and location sensor 322 may be combined for each of the Work and Home modes. For example, the presence contributions and the availability contributions from the calendar server 304 and the location sensor 322 may be summed for each of the Work and Home modes. This results in a presence value of 75 for the user in the Work mode and an availability value of −50 for the user in the Work mode. Similarly, this results in a presence value of 5 for the user in the Home mode and an availability value of −30 for the user in the Home mode. These may be described as:

Work Mode(availability,presence)=Work Mode(−50,+75)

Home Mode(availability,presence)=Home Mode(−30,+5)

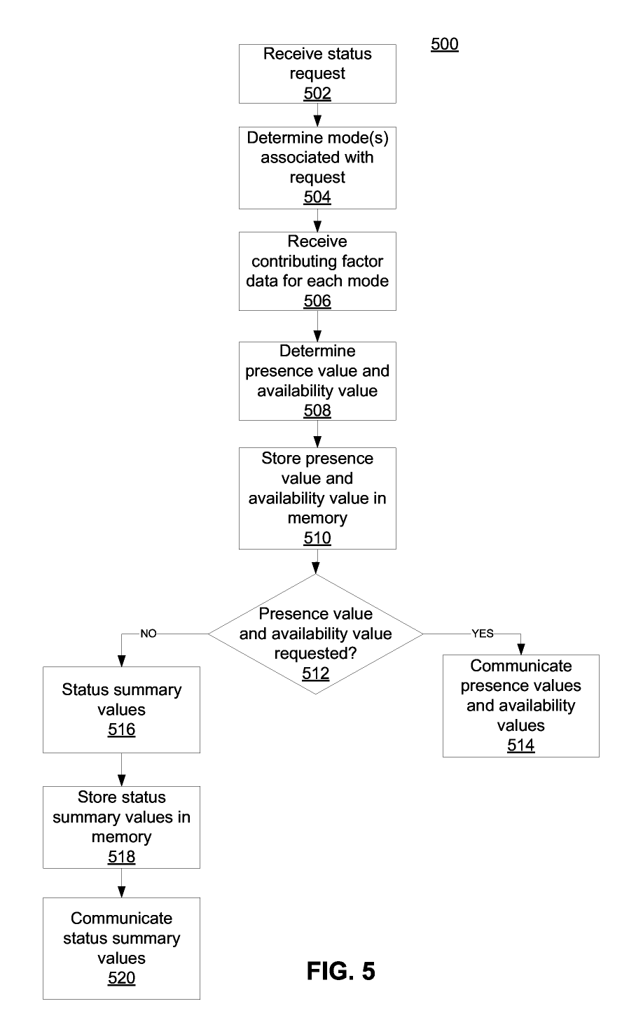

FIG. 5 illustrates an exemplary process 500 for determining and communicating a contextual presence status summary. The process may be initiated at block 502 when a contextual presence system receives a request from an agent for the status of a particular resource. An agent may be, for example, a remote messaging application executing on a remote device requesting the status of the user in order to determine whether to deliver a message to the user's device. In another example, the agent may be a notification coordinator service executing on the local device requesting the status of the user in order to determine whether (or how) to notify the user of a received message. For example, a resource may be a conference meeting room, a printing device, a user, or the like. Alternatively, or in addition, the process for determining a contextual presence status summary may be initiated at a predetermined time interval, e.g., every minute, hourly, daily, or the like. Initiating the process at a predetermined time interval may allow the status of the user to be readily available to be viewed or accessed.

At block 504, the contextual presence system may determine the modes associated with the status request. There may be any number of modes associated with a user. The modes may be default modes, custom modes, or a combination of the two. The default modes may be, for example, a Home mode, a Work mode, a Social mode, and a Mobile mode. One of ordinary skill in the art will recognize that many other modes are possible. Further, one or more of the default modes may be removed, and any number of custom modes may be added to meet the needs of a user.

While a user may be associated with any number of modes, the system may limit an agent's access to the status information associated with certain modes based on various attributes. For example, it may not be relevant to a user's coworkers whether the user is engaged in a Home mode, or in any mode other than a Work mode. Thus, a user may limit agents associated with coworkers to only access the user's status information with respect to the Work mode. In this case, when a status request is received from a coworker, the contextual presence system may determine that only the Work mode should be associated with the request. If the user grants access to coworkers to access any other modes, those modes may also be associated with the request.

In another example, the contextual presence system may associate a request with all available contextual presence information relating to all available modes associated with the user. This may be useful for displaying a complete view of the user's modes, presence values, and availability values, such as in an emergency situation or to a trusted agent.

At block 506, the contextual presence system may receive transition information for multiple modes from multiple contributing factors. In one example, the contextual presence system receives the transition information in response to requesting transition information from contributing factors. In another example, the contextual presence system receives the transition information on a predetermined time interval, e.g., every minute, hourly, daily, or the like. In yet another example, the contextual presence system receives the transition information in response to a change in the context of the user detected by the contributing factor.

At block 508, the contextual presence system may determine availability values and presence values for each of the modes associated with the request based on the transition information received from the contributing factors. Alternatively, the contextual presence system may determine availability values and presence values for all modes of the user, without regard to the modes associated with the request.

At block 510, the contextual presence system may store the determined availability values and presence values for each of the modes associated with the request in memory. The information may be stored, for example, in a database or in an array data structure. In one example, the contextual presence system may store all the determined availability values and presence values in memory.

At block 512, the contextual presence system may determine what results should be communicated. For example, the system may determine that the status request includes a request for separate presence values and availability values for each requested mode. In another example, the system may determine that the status request includes a request for presence values and availability values for particular modes. In yet another example, the system may determine that the requesting agent only has permission to access the presence value and availability value of a single mode. In yet another example, the system may determine that the requesting agent only has permission to access a status summary, which combines the availability values of multiple modes and the presence values of multiple modes.

At block 514, if the contextual presence system determines that presence values and availability values were requested for one or more modes and that the requesting agent has permission to access the values, the system may communicate these values to the agent. The values may be communicated via a network, such as the Internet or a LAN, via wired communication, or locally to a subsystem of the device executing the contextual presence system.

At block 516, if the contextual presence system determines that a status summary is requested or that the requesting agent only has permission to access a status summary, the system may determine the status summary values. In one example, a presence value of the status summary may be determined by calculating a weighted average of the presence values of several modes. An availability value of the status summary may be determined by calculating a weighted average of the availability values of the same modes. In another example, a presence value of the status summary may be determined by using the highest value (or lowest value) of the presence values of a set of modes. Similarly, an availability value of the status summary may be determined by using the lowest value (or highest value) of the presence values of a set of modes. The set of modes may be determined based on the modes requested by the agent, based on the modes the agent has access to view, or the like.

At block 518, the contextual presence system may store the determined presence value and availability value of the status summary in memory. The presence value and availability value of the status summary may be stored, for example, in a database or a data structure.

At block 520, the contextual presence system may communicate the status summary, including the presence value and the availability value of the status summary, to the agent. These values may be communicated via a network, such as the Internet or a LAN, via wired communication, or locally to a subsystem of the device executing the contextual presence system.

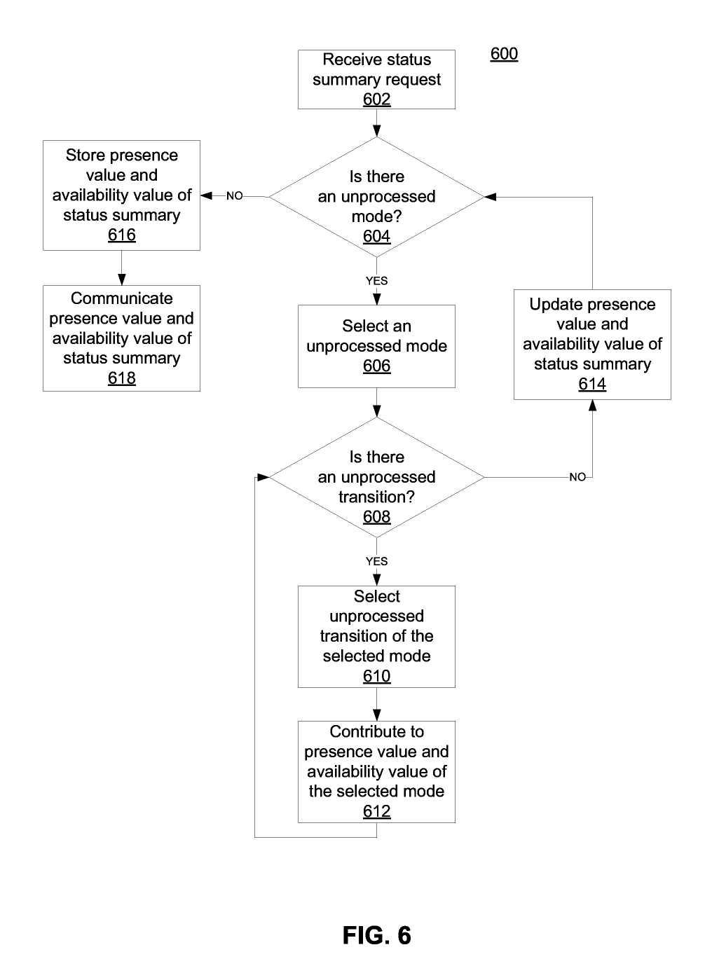

FIG. 6 illustrates an exemplary process 600 for determining a presence value and an availability value of a status summary. A status summary includes a generalized presence value and a generalized availability value.

At block 602, the system receives a status summary request. A request may be interpreted as a request for a status summary for numerous reasons. In one example, the agent may explicitly request a status summary. In another example, the agent may be restricted from accessing details of particular modes, but may have access to a status summary based on the restricted modes. In another example, the agent may be limited to only accessing a status summary. In this circumstance, the system may interpret any status request as a status summary request. One of skill in the art will readily recognize that there are numerous other circumstances in which a request may be interpreted as a status summary request, rather than a request for the details of one or more modes.

At block 604, the system determines if there are any unprocessed modes. A mode is unprocessed if the mode is associated with a user, the mode should be incorporated into the status summary of the agent requesting the status summary, and the mode has not yet been included in the determination of the status summary. In other words, the system analyzes each valid mode that should be included in the status summary.

At block 606, if there is an unprocessed mode, the system selects the mode to be analyzed. At block 608, the system determines if there are any unprocessed transitions for the selected mode. A transition is unprocessed if the transition is associated with the mode and the transition has not yet been included in the calculation of the availability value and/or presence value of the mode. In other words, the system analyzes each valid transition that should be included in the availability value and presence value of the mode.

At block 610, if there is unprocessed transition information for the selected mode, the transition information is selected. At block 612, the availability value and the presence value of the selected mode are updated using the selected transition information. For example, the transition information may make a positive or negative contribution to the availability value of the selected mode and a positive or negative contribution to the presence value of the selected mode. Returning to block 608, the system determines if there is another unprocessed transition for the selected mode. Thus, the presence value and availability value for the selected mode is determined through this process.

At block 614, the presence value and availability value of the status summary is updated using the presence value and availability value of the selected mode. In one example, the status summary is a weighted average of the modes. The weighted average allows the presence values and the availability values of certain modes to make more significant contributions to the presence value and availability value of the status summary. This may be used, for example, when a user manually provides input about the user's presence value and/or availability value. In this case, the user's direct input can be weighted much higher than that of other contributing factors.

In another example, the status summary may be updated by setting the status summary to the presence value and availability value of the mode with the highest presence value. In yet another example, the status summary may be updated by setting the status summary to the highest presence value of all modes and the highest availability value of all modes. In another example, the status summary may be updated by setting the status summary to the highest presence value of all modes and the lowest availability value of all modes.

At block 616, the presence value and the availability value of the status summary are stored in memory when there are no more unprocessed modes. The information may be stored, for example, in a database or in an array data structure. At block 618, the system communicates the presence value and availability value of the status summary. For example, the presence value and availability value of the status summary may be communicated to the agent that requested the status summary.

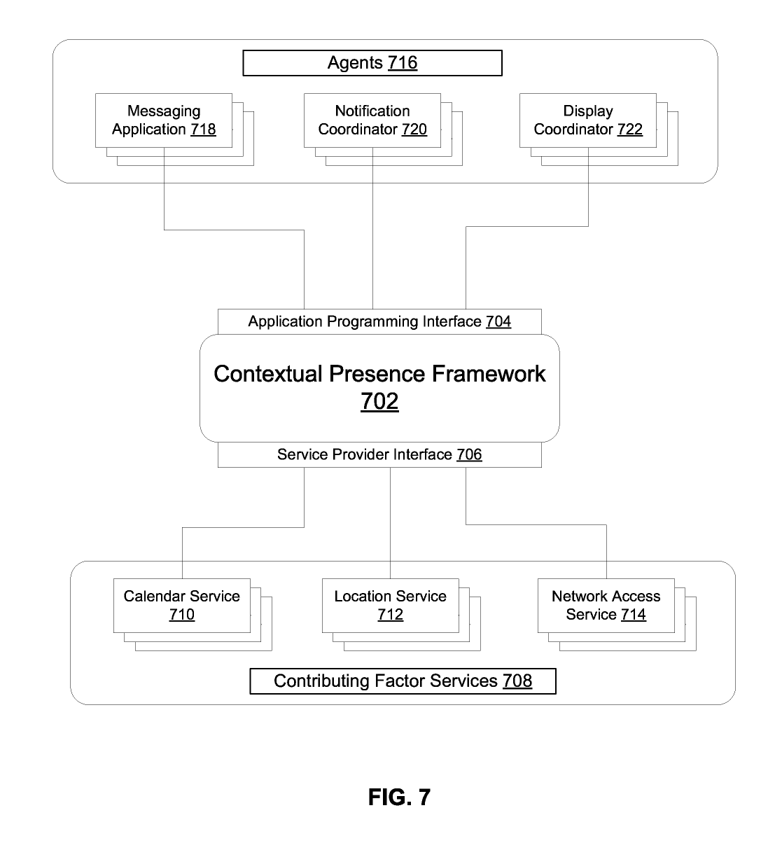

FIG. 7 illustrates an exemplary block diagram for providing an application programming interface (API) 704 and a service provider interface (SPI) 706. Contextual presence framework 702 is an extensible framework that includes API 704 and SPI 706. The API 704 provides query capabilities for agents 716 to list modes, availability values, presence values, and contextual presence status summaries. The SPI 706 allows developers and users to extend the system by registering new contributing factors, such as various sensors.

One particular interface of API 704, ModeAvailabilityService, returns a map of ModeAvailabilities. A ModeAvailability is a data structure that may contain a mode identifier, a presence value associated with the mode, an availability value associated with the mode, and ad hoc properties. ModeAvailabilityService may return the map of ModeAvailabilities associated with a user identification (ID) in response to a status request. Such direct requests are referred to as “direct queries.” ModeAvailabilityService may also enable a listener to be called when a ModeAvailability is changed for a particular user ID. Such requests for callbacks are referred to as “listener callbacks.”

Ad hoc properties may include data such as geo coordinates, a URL, a textual status message, or the like. The geo coordinate may provide the approximate location of the resource. The URL may refer to an image of a resource, a website homepage of a resource, or the like. The textual status message may include details relating to the status of the resource.

For listener callback APIs, agents 716 may register an event of interest with the contextual presence framework 702 through API 704. In one example, an event of interest may be any change in a presence value or an availability value of a user for one or more modes. In another example, an event of interest may be an increased availability value or presence value of a user for a specified mode. In yet another example, an event of interest may be a decrease of at least a determined amount of the availability value or presence value of a user for a specified mode. When an event of interest occurs, the contextual presence framework 702 calls back the agent 716 that registered the event of interest. This push-based model does not require that the agent 716 repeatedly poll the contextual presence framework 702 in order to detect an event of interest.

The ModeAvailabilityService API may also return ModeAvailabilities based on time. For example, the values of the ModeAvailability data structure returned may be based on the current time, a specified past time, or a specified future time (projections).

Projections enable the ModeAvailabilityService API to provide expected future presence values and availability values. The values returned to the agents 716 may be accompanied by associated confidence values. The confidence values may be expressed as a percentage, with 100% representing a high confidence that the projected presence values and availability values will be correct. Similarly, the system may return a separate confidence value for each of a mode, a presence value of a mode, and an availability value of a mode. Some contributing factors may be excluded when determining projections, such as contributing factors that do not provide insight (or do not provide reliable insight) into expected future presence values and availability values.

Calendar service 710 is one example of a contributing factor that may be used for projections. Calendar service 710 may provide accurate information about where a particular resource or user is expected to be at future days and times based on scheduled or proposed meetings. Location service 712 is another example of a contributing factor that may be used for projections. Location service 712 may provide insight into where a resource or user may be heading based on the current location, speed of travel, and direction of the resource or user.

Network access service 714 is one example of a contributing factor that may contribute to a resource's current presence values and availability values, but may be excluded when determining projections. Network access service 714 may detect information about multiple data networks that a device currently has access to, such as Bluetooth networks, cellular networks, and LANs. Similarly, network access service 714 may detect information about the type of data traffic on the networks that the device is transmitting or receiving, such as the content of websites being accessed. For example, network access service 714 may contribute transition information to a Home mode when the user is accessing a wireless network at the user's home to view news-related websites. Network access service 714 may interpret this information as the user engaging in a household-related activity, and the user being willing to be interrupted based on the nature of the activity. In contrast, if network access service 714 is not able to provide information relating to a projection of the user's presence value or availability value in any mode, network access service 714 may be excluded when determining projections.

Agents 716 may be required to register with the contextual presence framework 702 before accessing any status information. The registration process may include an authorization process. The registration process allows the framework to return customized results based on the agent 716 making the direct query or callback request. Through the registration and authorization process, specific modes of a user may be shared or hidden from certain agents 716. Thus, when an agent 716 requests a status from the contextual presence framework 702, the agent 716 will only receive a response based on the modes that the user has shared with the agent 716.

For example, display coordinator agent 722 may be authorized to receive a presence value and an availability value for all modes associated with the user, as well as a description of the modes. In another example, notification coordinator agent 720 may be authorized to receive a presence value and an availability value for a subset of the modes associated with the user, and the descriptions of the modes. In yet another example, messaging application agent 718 may only be authorized to receive a consolidated availability value and a consolidated presence value. In this case, contextual presence framework 702 may return the consolidated availability value and the consolidated presence value without a description of any associated modes to messaging application agent 718. For example, the consolidated availability value may be the largest of all availability values of modes associated with the user. Similarly, the consolidated presence value may be the largest of all presence values of modes associated with the user.

Importantly, contextual presence framework 702 allows for any number of contributing factor services 708 to be configured on mobile communication devices or servers. Each contributing factor service 708 may analyze a particular facet of a user's availability and presence, and provide this information to the contextual presence framework 702 in the form of transition information via SPI 706.

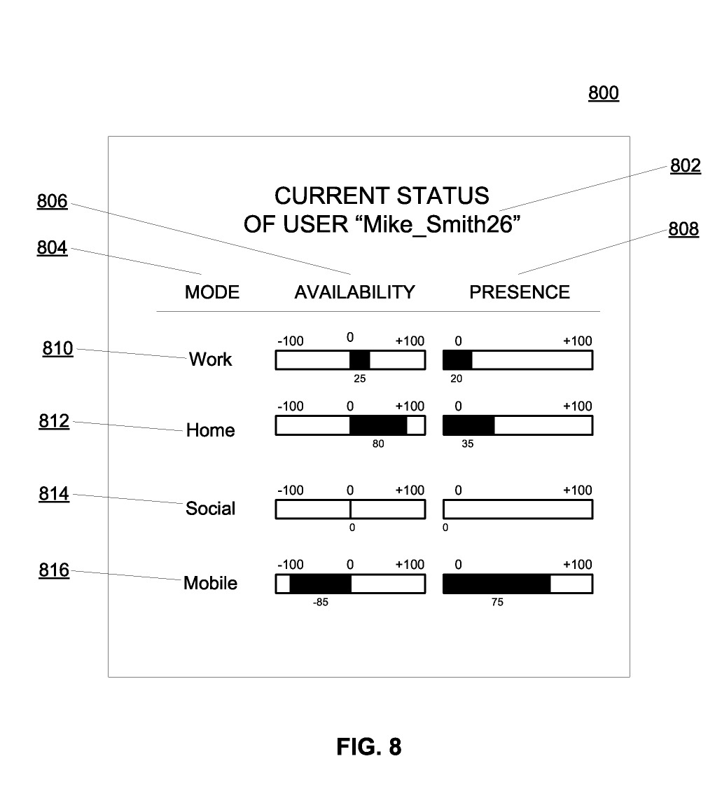

FIG. 8 illustrates an exemplary display 800 of the status information of a resource. In this particular example, the resource is a user associated with user account 802, named “Mike_Smith26.” An application has requested the status information for user 802 using the processes described, and the application is graphically displaying the results received. The exemplary display 800 may display all the modes associated with the user account 802 in the mode column 804. Each mode in mode column 804 may have a corresponding availability value displayed in the availability column 806, and a corresponding presence value displayed in the presence column 808. In this example, the user account 802 is associated with four modes: Work mode 810, Home mode 812, Social mode 814, and Mobile mode 816.

The user associated with user account 802 has a presence value of 20 and an availability value of 25 for the Work mode 810. The user has a presence value of 35 and an availability value of 80 for the Home mode 812. The user has a presence value of 0 and an availability value of 0 for the Social mode 814. The user has a presence value of 75 and an availability value of −85 for the Mobile mode 816.

The sum of the presence values of all modes associated with a user does not need to add up to any specific value. For example, a user may be simultaneously fully engaged in two modes, for example a Home mode and a Mobile mode. The sum of the availability values of all modes associated with a user also does not need to add up to any specific value. For example, a user may be fully available in both a Work mode and in a Home mode.

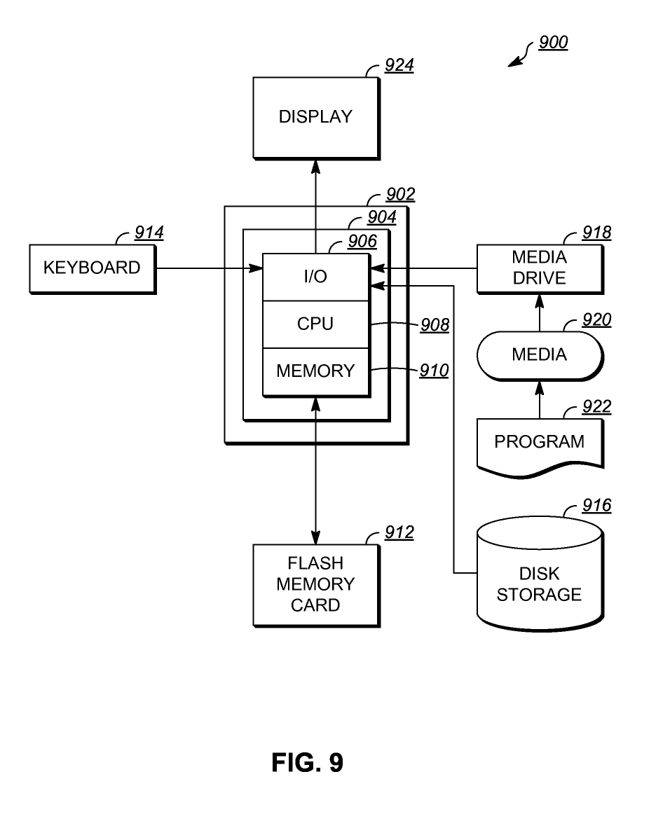

FIG. 9 depicts an exemplary computing system 900 configured to perform any one of the above-described processes. In this context, computing system 900 may include, for example, a processor, memory, storage, and input/output devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform the above-described processes. The main system 902 includes a motherboard 904 having an input/output (“I/O”) section 906, one or more central processing units (“CPU”) 908, and a memory section 910, which may have a flash memory card 912 related to it. The I/O section 906 is connected to a display 924, a keyboard 914, a disk storage unit 916, and a media drive unit 918. The media drive unit 918 can read/write a computer-readable medium 920, which can contain programs 922 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A computer-implemented method for determining a contextual status of a resource, the method comprising:
associating a plurality of modes with the resource, each mode representing a context;
determining a first presence value of the resource in a first mode of the plurality of modes;
determining a first availability value of the resource in the first mode; and
storing, in memory, the first presence value and the first availability value.

2. The computer-implemented method of claim 1, further comprising:
communicating the first presence value and the first availability value to a receiving system.

3. The computer-implemented method of claim 1, wherein:
the resource is a user;
the first presence value represents the extent to which the resource is engaged in the first mode; and
the first availability value represents the extent to which the resource is willing to be interrupted in the first mode.

4. The computer-implemented method of claim 1, wherein:
the resource is a user;
the first mode is selected from the group consisting of work, home, social, and mobile;
the first presence value is a real number representing a level of engagement of the resource in the first mode; and
the first availability value is a real number representing a level of accessibility to the resource in the first mode.

5. The computer-implemented method of claim 3, further comprising:
determining the first presence value based on at least a first contributing factor data, the first contributing factor data received from a first service associated with the resource; and
determining the first availability value based on at least a second contributing factor data, the second contributing factor data received from the first service associated with the resource.

6. The computer-implemented method of claim 5, further comprising:
determining a second presence value of the resource in a second mode of the plurality of modes;
determining a second availability value of the resource in the second mode; and
storing, in memory, the second presence value and the second availability value.

7. The computer-implemented method of claim 5, further comprising:
determining the first presence value based on at least a third contributing factor data, the third contributing factor data received from a second service associated with the resource; and
determining the first availability value based on at least a fourth contributing factor data, the fourth contributing factor data received from the second service associated with the resource; and
wherein the first contributing factor data, the second contributing factor data, the third contributing factor data, and the fourth contributing factor data are real numbers.

8. The computer-implemented method of claim 7, further comprising:
requesting contributing factor data from the first service;
receiving the first contributing factor data and the second contributing factor data from the first service in response to requesting contributing factor data from the first service;
requesting contributing factor data from the second service; and
receiving the third contributing factor data and the fourth contributing factor data from the second service in response to requesting contributing factor data from the second service.

9. The computer-implemented method of claim 8, further comprising:
determining a contextual presence status summary having a status summary availability value and a status summary presence value;
wherein the status summary presence value is a weighted average of the first presence value and the second presence value; and
wherein the status summary availability value is a weighted average of the first availability value and the second availability value.

10. A non-transitory computer-readable storage medium comprising computer-executable instructions for determining a contextual status of a resource, the instructions comprising:
associating a plurality of modes with the resource, each mode representing a context;
determining a first presence value of the resource in a first mode of the plurality of modes;
determining a first availability value of the resource in the first mode; and
storing, in memory, the first presence value and the first availability value.

11. The non-transitory computer-readable storage medium of claim 10, the instructions further comprising:
communicating the first presence value and the first availability value to a receiving system.

12. The non-transitory computer-readable storage medium of claim 10, wherein:
the resource is a user;
the first presence value represents the extent to which the resource is engaged in the first mode; and
the first availability value represents the extent to which the resource is willing to be interrupted in the first mode.

13. The non-transitory computer-readable storage medium of claim 10, wherein:
the resource is a user;
the first mode is selected from the group consisting of work, home, social, and mobile;
the first presence value is a real number representing a level of engagement of the resource in the first mode; and
the first availability value is a real number representing a level of accessibility to the resource in the first mode.

14. The non-transitory computer-readable storage medium of claim 12, the instructions further comprising:
determining the first presence value based on at least a first contributing factor data, the first contributing factor data received from a first service associated with the resource; and
determining the first availability value based on at least a second contributing factor data, the second contributing factor data received from the first service associated with the resource.

15. The non-transitory computer-readable storage medium of claim 14, the instructions further comprising:
determining a second presence value of the resource in a second mode of the plurality of modes;
determining a second availability value of the resource in the second mode; and
storing, in memory, the second presence value and the second availability value.

16. The non-transitory computer-readable storage medium of claim 14, the instructions further comprising:
determining the first presence value based on at least a third contributing factor data, the third contributing factor data received from a second service associated with the resource; and
determining the first availability value based on at least a fourth contributing factor data, the fourth contributing factor data received from the second service associated with the resource; and
wherein the first contributing factor data, the second contributing factor data, the third contributing factor data, and the fourth contributing factor data are real numbers.

17. The non-transitory computer-readable storage medium of claim 16, the instructions further comprising:
requesting contributing factor data from the first service;
receiving the first contributing factor data and the second contributing factor data from the first service in response to requesting contributing factor data from the first service;
requesting contributing factor data from the second service; and
receiving the third contributing factor data and the fourth contributing factor data from the second service in response to requesting contributing factor data from the second service.

18. The non-transitory computer-readable storage medium of claim 17, the instructions further comprising:
determining a contextual presence status summary having a status summary availability value and a status summary presence value;
wherein the status summary presence value is a weighted average of the first presence value and the second presence value; and
wherein the status summary availability value is a weighted average of the first availability value and the second availability value.

19. An apparatus for determining a contextual status of a resource, the apparatus comprising:
a memory configured to store data; and
a computer processor configured to:
associate a plurality of modes with the resource, each mode representing a context;
determine a first presence value of the resource in a first mode of the plurality of modes;
determine a first availability value of the resource in the first mode; and
store, in the memory, the first presence value and the first availability value.

20. The apparatus of claim 19, wherein the computer processor is further configured to:
communicate the first presence value and the first availability value to a receiving system.

21. The apparatus of claim 19, wherein:
the resource is a user;
the first presence value represents the extent to which the resource is engaged in the first mode; and
the first availability value represents the extent to which the resource is willing to be interrupted in the first mode.

22. The apparatus of claim 19, wherein:
the resource is a user;
the first mode is selected from the group consisting of work, home, social, and mobile;
the first presence value is a real number representing a level of engagement of the resource in the first mode; and
the first availability value is a real number representing a level of accessibility to the resource in the first mode.

23. The apparatus of claim 21, wherein the computer processor is further configured to:
determine the first presence value based on at least a first contributing factor data, the first contributing factor data received from a first service associated with the resource; and
determine the first availability value based on at least a second contributing factor data, the second contributing factor data received from the first service associated with the resource.

24. The apparatus of claim 23, wherein the computer processor is further configured to:
determine a second presence value of the resource in a second mode of the plurality of modes;
determine a second availability value of the resource in the second mode; and
store, in the memory, the second presence value and the second availability value.

25. The apparatus of claim 23, wherein the computer processor is further configured to:
determine the first presence value based on at least a third contributing factor data, the third contributing factor data received from a second service associated with the resource; and
determine the first availability value based on at least a fourth contributing factor data, the fourth contributing factor data received from the second service associated with the resource; and
wherein the first contributing factor data, the second contributing factor data, the third contributing factor data, and the fourth contributing factor data are real numbers.

26. The apparatus of claim 25, wherein the computer processor is further configured to:
request contributing factor data from the first service;
receive the first contributing factor data and the second contributing factor data from the first service in response to requesting contributing factor data from the first service;
request contributing factor data from the second service; and
receive the third contributing factor data and the fourth contributing factor data from the second service in response to requesting contributing factor data from the second service.

27. The apparatus of claim 26, wherein the computer processor is further configured to:
determine a contextual presence status summary having a status summary availability value and a status summary presence value;
wherein the status summary presence value is a weighted average of the first presence value and the second presence value; and
wherein the status summary availability value is a weighted average of the first availability value and the second availability value.
